(19) United States
(12) Patent Application Publication
(10) Pub. No.: US 2025/0326368 A1
(43) Pub. Date: Oct. 23, 2025

(54) CURTAIN AIRBAG DEVICE

(71) Applicant: SUBARU CORPORATION, Tokyo (JP)

(72) Inventor: Kazushige ISHIBASHI, Tokyo (JP)

(21) Appl. No.: 19/097,150

(22) Filed: Apr. 1, 2025

(30) Foreign Application Priority Data
Apr. 22, 2024 (JP) 2024-069168

(51) Int. Cl. B60R 21/232; B60R 21/213; B60R 21/217

(52) U.S. Cl. CPC B60R 21/232; B60R 21/213; B60R 21/2171

(57) ABSTRACT

A curtain airbag device configured to be assembled in a vehicle body of a vehicle includes an airbag and a bracket. The airbag is configured to be fixed to the vehicle body in a stored state. The bracket is configured to retain the airbag in the stored state. In an intermediate part of the bracket in an extending direction thereof, at least a first cutout and a second cutout are disposed side by side in the extending direction.

### CROSS-REFERENCE TO RELATED APPLICATIONS

The present application claims priority from Japanese Patent Application No. 2024-069168 filed on Apr. 22, 2024, the entire contents of which are hereby incorporated by reference.

### BACKGROUND

The disclosure related to a curtain airbag device.

A head protection airbag device is mainly provided with an airbag that inflates and deploys, an inflator for supplying an inflation gas to the airbag, an attachment mechanism for attaching the airbag to a vehicle body, and a case for accommodating the airbag in a folded state. The head protection airbag is disposed along a roof side rail from a front pillar of the vehicle body. The airbag in the folded state is disposed in a storage space between a trim and the vehicle body.

The case has a substantially U-shape in cross-sectional view. The case is attached to the vehicle body with an opening of the case facing a lower side of the vehicle body. When the vehicle collides, the airbag protrudes from the opening to inflate and deploy toward the vehicle cabin, and protects the head of an occupant.

### SUMMARY

An aspect of the disclosure provides a curtain airbag device configured to be assembled in a vehicle body of a vehicle. The curtain airbag device includes an airbag and a bracket. The airbag is configured to be fixed to the vehicle body in a stored state. The bracket is configured to retain the airbag in the stored state. In an intermediate part of the bracket in an extending direction thereof, at least a first cutout and a second cutout are disposed side by side in the extending direction.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic view illustrating a curtain airbag device according to an embodiment of the disclosure.

FIG. 2 is a schematic view illustrating a curtain airbag device according to the embodiment of the disclosure.

FIG. 3 is a side view illustrating a curtain airbag device according to the embodiment of the disclosure.

FIG. 4 is a perspective view illustrating a curtain airbag device according to the embodiment of the disclosure.

FIG. 5A is a perspective view illustrating a curtain airbag device according to the embodiment of the disclosure.

FIG. 5B is a perspective view illustrating a curtain airbag device according to the embodiment of the disclosure.

FIG. 6 is a perspective view illustrating a curtain airbag device according to the embodiment of the disclosure.

### DETAILED DESCRIPTION

Known examples of existing head protection airbag devices include a structure described in Japanese Patent No. 6879249.

As described above, the airbag is disposed along the roof side rail from the front pillar. The airbag in the folded state is accommodated in at least two cases along the entire length of the airbag, and the folded state is kept.

In the structure for accommodating the airbag in the cases, the cases are coupled by a coupling member to prevent the airbag from being fixed to the vehicle body in a twisted state. In the structure, the two cases and the coupling member are provided as different members, and a fixing member for coupling is also used. This increases the number of components as the head protection airbag device and incurs increased mold costs, which makes it difficult to reduce manufacturing costs.

The disclosure relates to a curtain airbag device that achieves reduced manufacturing costs by implementing a desired packed state during transportation and reducing the number of components.

Hereinafter, a curtain airbag device 10 according to an embodiment of the disclosure will be described in detail with reference to the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. In the description of the embodiment, the same reference numerals are used for the same members in principle, and repetitive description will be omitted. In the drawings, a front-rear direction indicates a front-rear direction of a vehicle 11, a left-right direction indicates a width direction of the vehicle 11, and an up-down direction indicates a height direction of the vehicle 11.

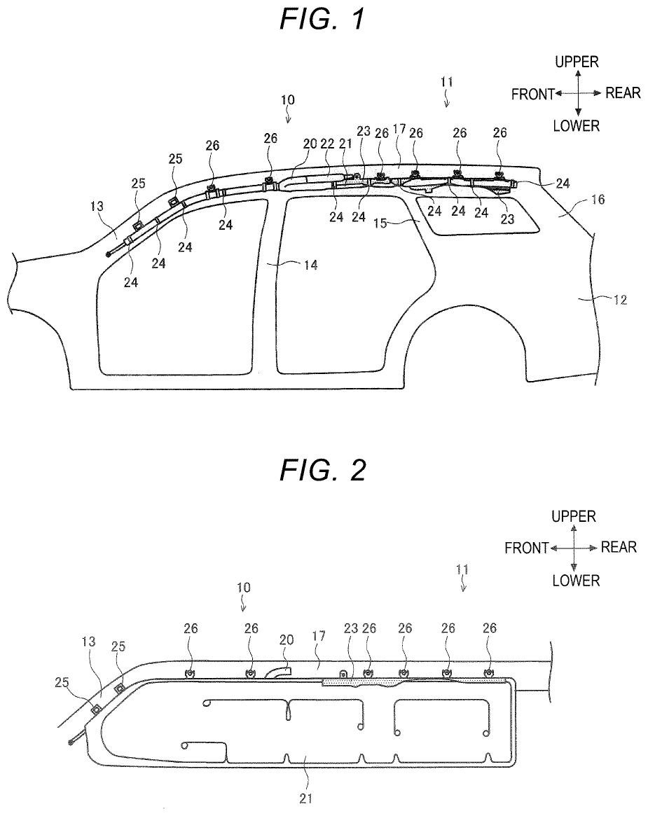

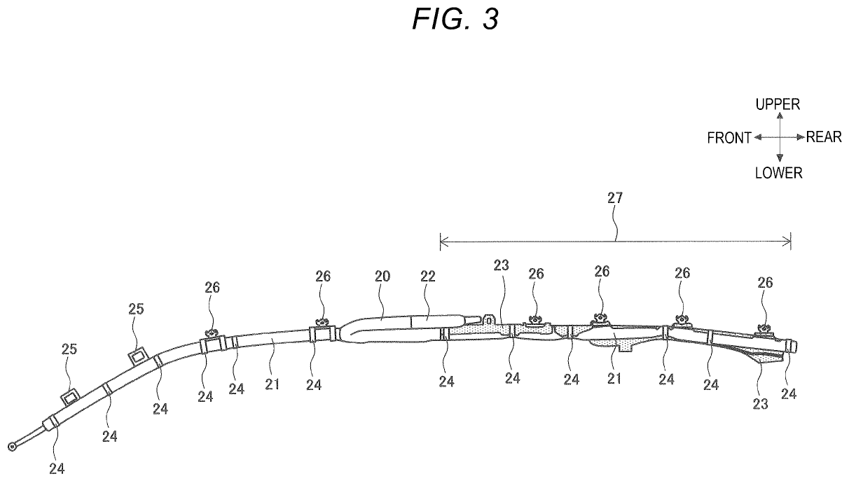

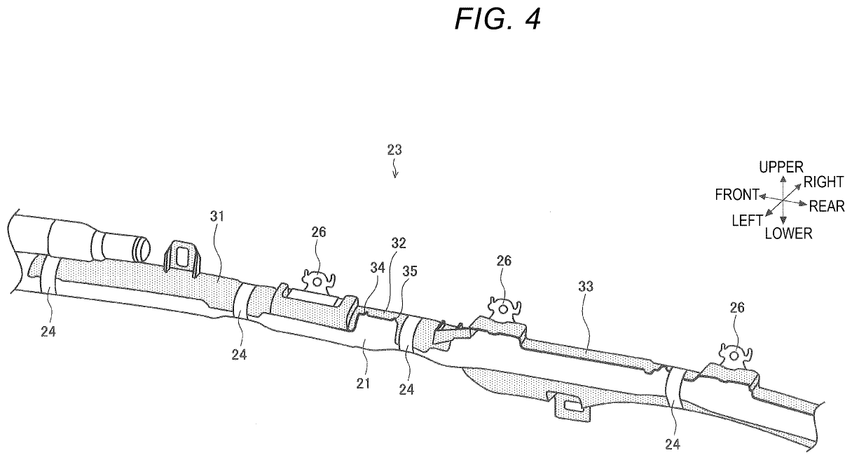

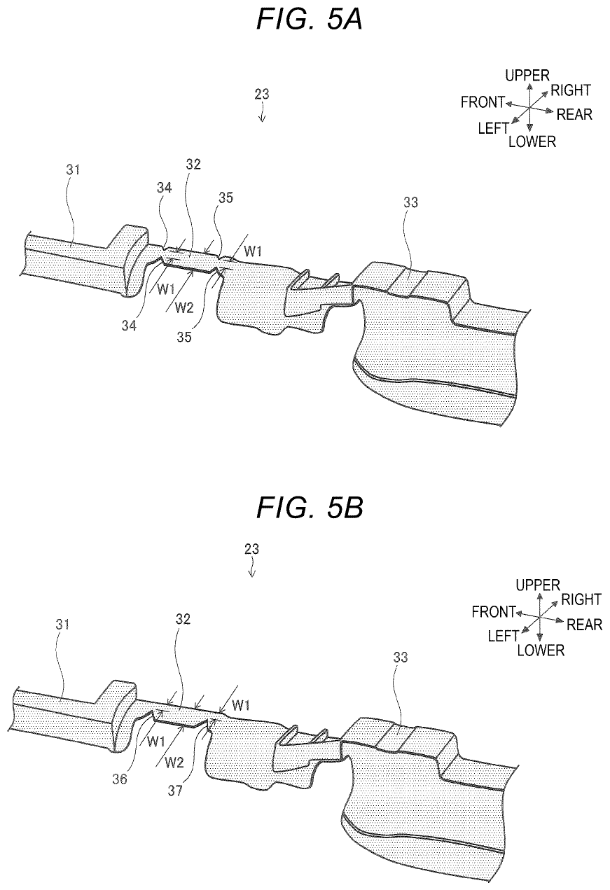

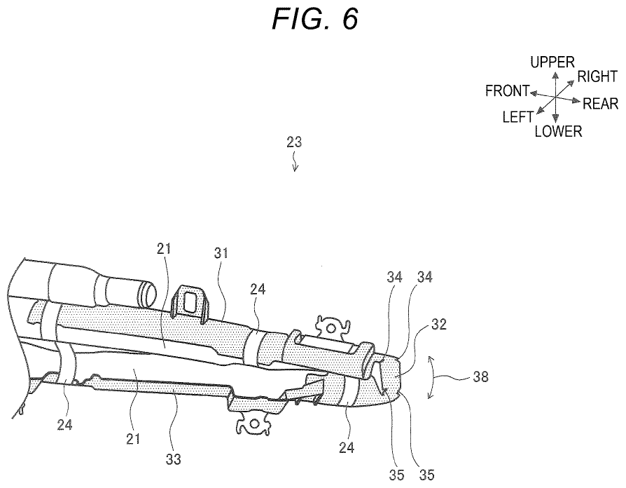

FIG. 1 is a schematic view illustrating the curtain airbag device 10 in a pre-inflated and pre-deployed state according to the embodiment. FIG. 2 is a schematic view illustrating the curtain airbag device 10 in a post-inflated and post-deployed state according to the embodiment. FIG. 3 is a side view illustrating a region in which a bracket 23 of the curtain airbag device 10 according to the embodiment is attached. FIG. 4 is a perspective view illustrating the bracket 23 of the curtain airbag device 10 according to the embodiment. FIG. 5A is a perspective view illustrating the bracket 23 of the curtain airbag device 10 according to the embodiment. FIG. 5B is a perspective view illustrating the bracket 23 of the curtain airbag device 10 according to the embodiment. FIG. 6 is a perspective view illustrating the bracket 23 of the curtain airbag device 10 according to the embodiment.

As illustrated in FIG. 1, examples of the vehicle 11 in which the curtain airbag device 10 is assembled include an engine-powered vehicle, an electric vehicle (EV), a hybrid electric vehicle (HEV), and a plug-in hybrid electric vehicle (PHEV).

Further, a vehicle body 12 on the driver's seat side is illustrated in FIG. 1. The vehicle body 12 includes, for example, from the front side thereof, a front pillar 13, a center pillar 14, a quarter pillar 15, and a rear pillar 16. Upper parts of the pillars 13 to 16 are joined to a roof side rail 17 extending in the front-rear direction of the vehicle body 12.

The curtain airbag device 10 mainly includes an airbag 21, an inflator 22 that supplies a gas to the airbag 21, the bracket 23 that retains the airbag 21 in a stored state, a fixing tape 24 that fixes the airbag 21 in the stored state, and a fixing tag 25 and a fixing plate 26 that attaches the airbag 21 to the vehicle body 12. Before the airbag 21 is inflated and deployed, the curtain airbag device 10 is stored in a space between the vehicle body 12 and a trim (not illustrated).

The airbag 21 is a bag-like body made of cloth which is inflated and deployed by receiving a high-pressure gas ejected from the inflator 22. Before being inflated and deployed, the airbag 21 is retained, in the vehicle body 12, in a rolled state in which the airbag 21 is wound thinly in the up-down direction of the vehicle 11. The airbag 21 is disposed along the front pillar 13 and the roof side rail 17, and is fixed to the vehicle body 12 via the fixing tag 25 and the fixing plate 26.

The airbag 21 is provided with a gas introducer 20. The airbag 21 is coupled to, for example, the inflator 22 fixed to the roof side rail 17 above the center pillar 14 via the gas introducer 20. The stored state of the airbag 21 is not limited to a state in which the airbag 21 is folded in a rolled manner, and the stored state may be a state in which the airbag 21 is folded into a bellows shape.

As illustrated in FIG. 2, in the curtain airbag device 10, in the event of an emergency such as a side collision or rollover of the vehicle 11, a high-pressure gas is ejected from the inflator 22 (see FIG. 1) into the airbag 21. Then, the airbag 21 is inflated and deployed in the front-rear direction of the vehicle 11. At this time, the airbag 21 is inflated to break the fixing tape 24. Then, the airbag 21 normally inflates and deploys downward from the fixed position such as the roof side rail 17, i.e., toward the inside of the vehicle cabin. As a result, the airbag 21 is disposed between the vehicle body 12 and a head of an occupant to thereby protect the head of the occupant.

FIG. 3 illustrates the curtain airbag device 10 in a pre-inflated and pre-deployed state. The airbag 21 in the stored state is disposed to extend in the front-rear direction of the vehicle body 12. The inflator 22 is disposed at the center of the airbag 21. The inflator 22 communicates with the gas introducer 20.

The airbag 21 that is located more toward the front of the vehicle body 12 than the inflator 22 is maintained in the stored state by using the fixing tape 24. The airbag 21 is fixed to the vehicle body 12 via the fixing tag 25 and the fixing plate 26.

On the other hand, as indicated by an arrow 27, the airbag 21 that is located more toward the rear of the vehicle body 12 than the inflator 22 is maintained in the stored state by using the bracket 23 and the fixing tape 24. The airbag 21 is fixed to the vehicle body 12 via the fixing plate 26.

As illustrated in the drawing, in a region where the bracket 23 is disposed, the fixing tape 24 is wound around the airbag 21 in the stored state to fix the airbag 21 in some cases, and the fixing tape 24 is wound around the airbag 21 and the bracket 23 together to fix the airbag 21 in other cases. According to the structure, even in the region where the bracket 23 is disposed, the fixing tape 24 breaks in response to the airbag 21 being inflated and deployed, and the airbag 21 is deployed downward from the bracket 23. The fixing plate 26 is fixed to the vehicle body 12. The bracket 23 is fixed to the fixing plate 26, which maintains the state in which the bracket 23 is fixed to the vehicle body 12 even after the airbag 21 is inflated and deployed.

As illustrated in FIG. 4, the bracket 23 includes, from the front side of the vehicle body 12, a first bracket 31, a coupler 32, and a second bracket 33. The first bracket 31 and the second bracket 33 are coupled to each other via the coupler 32. In other words, the bracket 23 is provided as one part by, for example, resin molding.

The first bracket 31 is disposed on the upper side of the airbag 21 in the stored state. On the other hand, the second bracket 33 is disposed on the upper side and the back side of the airbag 21 in the stored state. The coupler 32 is coupled to the first and second brackets 31 and 33 on the upper side of the airbag 21 in the stored state.

According to the structure, when the airbag 21 is inflated and deployed in the region where the bracket 23 is disposed, the airbag 21 is easily inflated and deployed toward the inside of the vehicle cabin. This is because the first and second brackets 31 and 33 are open toward the inside of the vehicle cabin.

In one example, a region where the second bracket 33 is disposed is a region where the airbag 21 is inflated and deployed at the end. The shape of the second bracket 33 described above makes it easier to control the direction of inflation and deployment of the airbag 21.

As a result, the airbag 21 having been inflated and deployed normally is positioned between the vehicle body 12 and the head of the occupant. This protects the head or the like of the occupant when the vehicle 11 collides. As described above, also in a rear seat of the vehicle 11, the airbag 21 is inflated and deployed in a desired region, so that the head or the like of the occupant can be protected.

As illustrated in FIG. 5A, the coupler 32 is disposed in an intermediate part of the bracket 23 and has a substantially planar shape. On the coupler 32, a first cutout 34 and a second cutout 35 are provided side by side in the extending direction of the airbag 21 (front-rear direction in the drawing). The first cutout 34 is provided closer to the front side of the vehicle 11 than the second cutout 35 is. The first cutouts 34 making a pair are provided on ends of the coupler 32 in the lateral width direction of the coupler 32 (left-right direction in the drawing). In other words, the two first cutouts 34 are provided to face each other on ends of the coupler 32 of the bracket 23 in a direction (left-right direction in the drawing) intersecting with the extending direction of the bracket 23 (front-rear direction in the drawing).

Similarly, the second cutouts 35 making a pair are provided on ends of the coupler 32 in the lateral width direction of the coupler 32 (left-right direction in the drawing). In other words, the two second cutouts 35 are provided to face each other on ends of the coupler 32 of the bracket 23 in the direction (left-right direction in the drawing) intersecting with the extending direction of the bracket 23 (front-rear direction in the drawing).

The first and second cutouts 34 and 35 each have a substantially triangular shape when viewed from above. Lateral widths W1 of the coupler 32 in regions where the first and second cutouts 34 and 35 are provided are each smaller than a lateral width W2 of the coupler 32 in the other regions. As described above, the coupler 32 is formed by resin molding, and therefore is flexible.

According to the structure, the bracket 23 can be folded using the first and second cutouts 34 and 35 of the coupler 32. The bracket 23 can be folded at, for example, the coupler 32 by 180 degrees or so, which enables the second bracket 33 to be disposed to face the first bracket 31.

Meanwhile, the coupler 32 is bent within the range of elastic deformation. When being attached to the vehicle body 12, the coupler 32 is restored. The first bracket 31 and the second bracket 33 have a desired positional relationship via the coupler 32, so that the airbag 21 of the curtain airbag device 10 is attached to a desired position of the vehicle body 12 without being twisted. As a result, the airbag 21 is inflated and deployed in a desired region in the vehicle cabin as described above. This prevents the product quality of the curtain airbag device 10 from deteriorating.

Further, the bracket 23 of the embodiment is provided as one part as described above, which reduces mold costs for forming the bracket 23 by resin molding. Moreover, a fixing component such as a screw for coupling the first bracket 31, the coupler 32, and the second bracket 33 also becomes unnecessary. As a result, the manufacturing costs of the curtain airbag device 10 is reduced.

As illustrated in FIG. 5B, a structure is possible in which a first cutout 36 and a second cutout 37 are each provided at one location on one end of the coupler 32 in the lateral width direction. In other words, a structure is possible in which the first and second cutouts 36 and 37 are each provided at one location on an end of the coupler 32 of the bracket 23 in the direction (left-right direction in the drawing) intersecting with the extending direction of the bracket 23 (front-rear direction in the drawing). In such a case, for example, the first and second cutouts 36 and 37 are provided to have a shape larger than that of the first and second cutouts 34 and 35 illustrated in FIG. 5A.

According to the structure, the bracket 23 can be folded at the coupler 32 by 180 degrees or so, which enables the second bracket 33 to be disposed to face the first bracket 31. It should be noted that the first and second cutouts 36 and 37 are simply provided on any one of the ends of the coupler 32 in the outer peripheral direction of the airbag 21 stored in a substantially columnar shape.

As illustrated in FIG. 6, the bracket 23 can be folded using the first and second cutouts 34 and 35 of the coupler 32. While being transported, the curtain airbag device 10 can be folded in half in the region where the bracket 23 of the airbag 21 is disposed.

An example of conditions for transporting the curtain airbag device 10 is to keep the length of the curtain airbag device 10 in a packed state within 900 mm. Meeting the conditions reduces the transportation cost. As described above, the coupler 32 is folded by 180 degrees or so via the first cutouts 34 and 36 and the second cutouts 35 and 37 in the region where the bracket 23 of the airbag 21 in the stored state is disposed. Thereby, the curtain airbag device 10 is folded into three. As a result, the conditions as the packed state of 900 mm can be met.

Further, as illustrated in the drawing, in the region where the bracket 23 is disposed, the fixing tape 24 is not disposed in a region between the first cutouts 34 and 36 and the second cutouts 35 and 37 of the coupler 32, as indicated by an arrow 38. In other words, the fixing tape 24 is wound around the airbag 21 and the bracket 23 outside the region between the first cutouts 34 and 36 and the second cutouts 35 and 37 of the coupler 32.

According to the structure, the coupler 32 is folded while the curtain airbag device 10 is transported, and breakage of the fixing tape 24 due to inflation or twisting of the airbag 21 is prevented.

In the embodiment, the case is described where the bracket 23 as one part is disposed more toward the rear of the vehicle 11 than the center of the airbag 21. However, the disclosure is not limited to the case. For example, the bracket 23 as one part may be disposed more toward the front of the vehicle 11 than the center r of the airbag 21. In addition, various modifications are possible without departing from the gist of the disclosure.

In the curtain airbag device according to an embodiment of the disclosure, the first cutout and the second cutout are disposed side by side in the extending direction of the airbag in the intermediate part of the bracket that retains the airbag in the stored state. The structure allows the airbag to be folded in a desired packed state while the curtain airbag is transported. Further, the bracket is provided as one part. This reduces the number of components, leading to reduction in the manufacturing costs.

1. A curtain airbag device configured to be assembled in a vehicle body of a vehicle, the curtain airbag device comprising:
an airbag configured to be fixed to the vehicle body in a stored state; and
a bracket configured to retain the airbag in the stored state, wherein
in an intermediate part of the bracket in an extending direction thereof, at least a first cutout and a second cutout are disposed side by side in the extending direction.

2. The curtain airbag device according to claim 1, wherein
the bracket comprises a first bracket and a second bracket configured to retain the airbag, and a coupler configured to couple the first bracket and the second bracket to each other, and
the first cutout and the second cutout are disposed in the coupler.

3. The curtain airbag device according to claim 1, further comprising a fixing tape configured to fix the airbag in the stored state, wherein
the fixing tape fixes the airbag in a region other than a region between the first cutout and the second cutout.

4. The curtain airbag device according to claim 2, further comprising a fixing tape configured to fix the airbag in the stored state, wherein
the fixing tape fixes the airbag in a region other than a region between the first cutout and the second cutout.

5. The curtain airbag device according to claim 3, wherein one or more first cutouts comprising the first cutout and one or more second cutouts comprising the second cutout are provided at an end of the intermediate part of the bracket in a direction intersecting with the extending direction.

6. The curtain airbag device according to claim 4, wherein one or more first cutouts comprising the first cutout and one or more second cutouts comprising the second cutout are provided at an end of the intermediate part of the bracket in a direction intersecting with the extending direction.

7. The curtain airbag device according to claim 5, wherein
the one or more first cutouts are disposed at the end of the intermediate part of the bracket so as to face each other in the direction intersecting with the extending direction, and
the one or more second cutouts are disposed at the end of the intermediate part of the bracket so as to face each other in the direction intersecting with the extending direction.

8. The curtain airbag device according to claim 6, wherein
the one or more first cutouts are disposed at the end of the intermediate part of the bracket so as to face each other in the direction intersecting with the extending direction, and
the one or more second cutouts are disposed at the end of the intermediate part of the bracket so as to face each other in the direction intersecting with the extending direction.
